(19) United States
(12) Patent Application Publication
(10) Pub. No.: US 2012/0298160 A1
(43) Pub. Date: Nov. 29, 2012

(54) WALKER FOR USE ON STAIRS

(76) Inventor: James T. Hamilton, Naperville, IL (US)

(21) Appl. No.: 13/114,814

(22) Filed: May 24, 2011

(51) Int. Cl. A61H 3/00

(52) U.S. Cl. 135/66; 135/67

(57) ABSTRACT

A walker which can be used on stairs as well as on a level surface. The walker has legs which are comprised of hydraulic cylinders with integral pistons. Each pair of legs is part of a frame. The walker is configured such that each frame provides that fluid can flow from one leg of the frame to the other. Because the fluid is generally incompressible and the amount of fluid in each frame is fixed, movement of one piston of the frame causes the other piston of the frame to move. As such, as one leg of the frame lengthens, the other leg of the frame automatically shortens in response, and vise versa. While the walker is configured such that the legs can be shortened and lengthened, preferably the walker is also configured such that the legs can be locked in place.

### BACKGROUND OF THE INVENTION

An embodiment of the present invention generally relates to walkers, and more specifically relates to a walker designed for use on stairs.

Conventional four point walkers are used by many people (such as handicapped, aged, wounded or convalescing persons) in order to provide them with more stability for walking across a level surface. However, a conventional four point walker is not very useful or safe for ascending or descending a flight of stairs.

### SUMMARY OF THE INVENTION

An object of an embodiment of the present invention is to provide a walker that can be used on stairs as well as on a level surface. Specifically, an embodiment of the present invention provides a walker having legs which are comprised of hydraulic cylinders with integral pistons. Each pair of legs is part of a frame. As such, the walker consists of two frames—one frame forming the right side of the walker, and one frame forming the left side of the walker. The two frames are connected by at least one cross member. The walker is configured such that each frame provides that fluid can flow from one leg to the other within the frame. Because the amount of fluid in each frame is fixed, movement of one piston of the frame causes the other piston of the frame to move. As such, as one leg of the frame lengthens, the other leg of the frame automatically shortens in response, and vise versa. While the walker is configured such that the legs can be shortened and lengthened, preferably the walker is also configured such that the legs can be locked in place.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a perspective view of a walker which is in accordance with an embodiment of the present invention;

FIG. 2 is a representative partial cross-sectional view of one of the hydraulic cylinders of the walker shown in FIG. 1, wherein the view is taken along line 2-2 of FIG. 1;

FIG. 3 illustrates an alternative version of a seal component of the hydraulic cylinder which is shown in FIG. 2; and

FIG. 4 shows the walker of FIG. 1 being employed on a set of stairs, wherein the left side of FIG. 4 shows the walker ascending the stairs, and the right side of FIG. 4 shows the walker descending the stairs.

### DETAILED DESCRIPTION OF ILLUSTRATED EMBODIMENTS

While this invention may be susceptible to embodiment in different forms, there are shown in the drawings and will be described herein in detail, specific embodiments with the understanding that the present disclosure is to be considered an exemplification of the principles of the invention, and is not intended to limit the invention to that as illustrated.

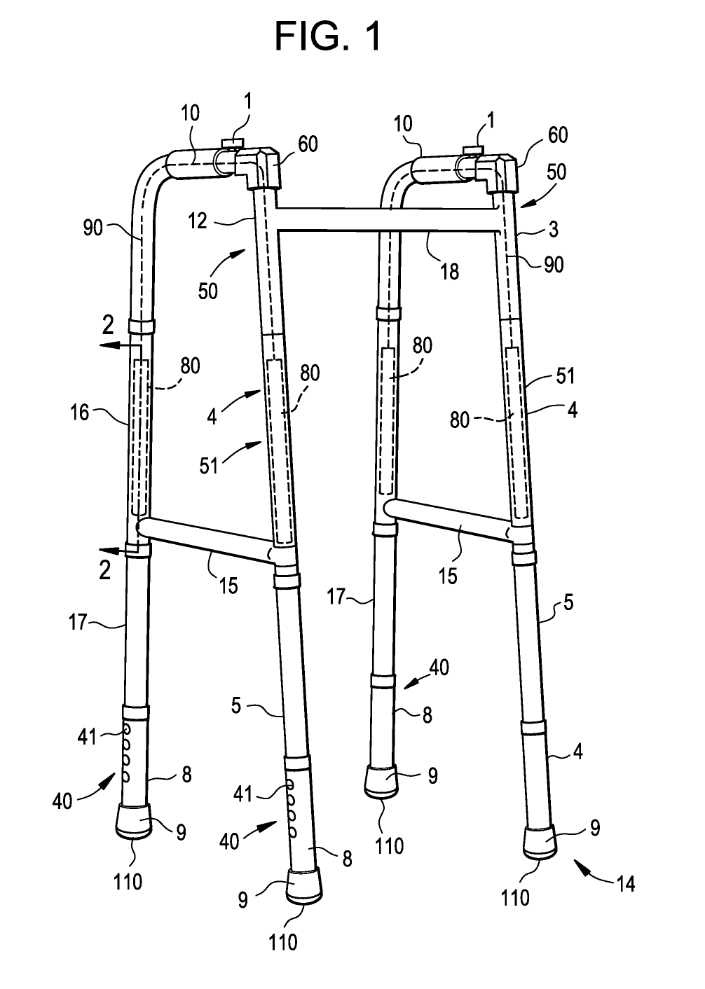

FIG. 1 illustrates a walker 14 which is in accordance with an embodiment of the present invention. As shown, the walker 14 consists of two frames 4, and the two frames 4 are connected via at least one cross member 18. Each frame 4 is comprised of a rear leg 17 and a front leg 5. Each of the legs 5, 17 is selectively extendable and retractable, as will be described in more detail later herein. Each leg 5, 17 is engaged with, and extends into, a lower tube 8. Preferably, a rubber cap 9 is engaged with the end of each lower tube 8, thereby defining bottom, ground-engaging surfaces 110 of the walker 14. Specifically, preferably each leg 5, 17 slides into a respective lower tube 8 and is engaged with the lower tube 8 such that the normal operable height of the walker 14 can be adjusted by adjusting the position of each leg 5, 17 relative to the lower tube 8, and locking the position in place. To this end, preferably each lower tube 8 has a number of spaced holes 40 which are in line with a spring-loaded detent 41 (only the holes 40 and spring-loaded detent of one side of the walker 14 are shown in FIG. 1) which is provided on the lower end of each leg 5, 17. To change the standard operating height of each leg 5, 17, the respective spring-loaded detent 41 is pushed in, the position of the lower tube 8 relative to the leg 5, 17 is adjusted, and the spring loaded detent 41 is released, thereby locking the lower tube 8 and leg 5, 17 in position relative to each other. Of course, alternative structure besides a spring-loaded detent 41 and a plurality of holes 40 can be employed to provide that the standard operating length of each leg 5, 17 is adjustable.

Each frame 4 also includes a tubular upper portion 50 as well as a tubular middle portion 51 which is engaged with the upper portion 50. The legs 5, 17 extend up into the middle portion 51, and each middle portion 51 includes a cross tube 15. Each upper portion 50 preferably includes a hand grip 10 as well as a corner cap 60. Preferably, each upper portion 50 also includes a spring-loaded detent 12 (only one of which is shown in FIG. 1) which provides that the walker 14 can be folded about the corner caps 60 for easy portability and storage. Each upper portion 50 also preferably includes a ball valve 1, which will be described more fully later hereinbelow. Of course, alternative structure besides a spring-loaded detent 12, etc. can be employed to provide that the walker 14 is foldable.

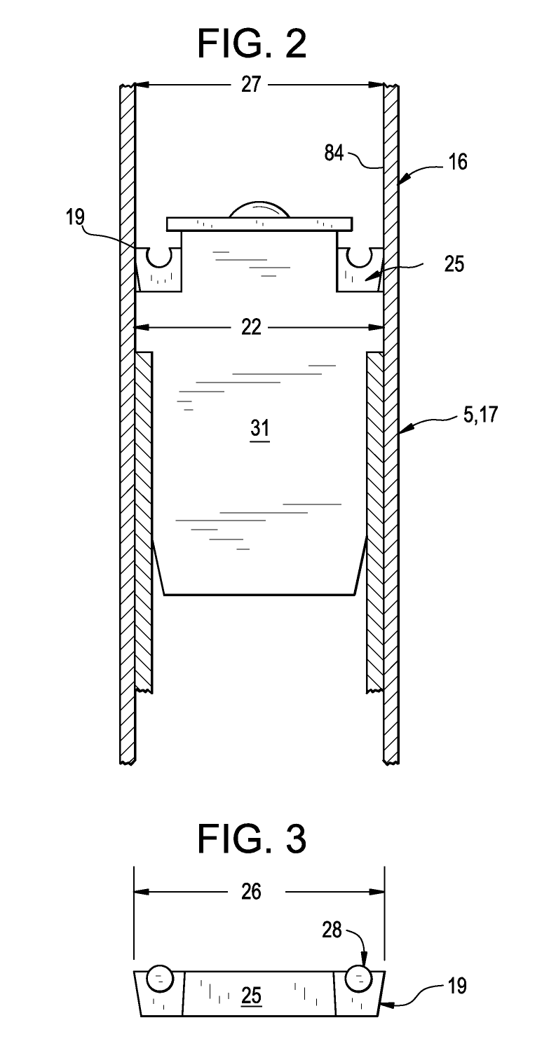

FIG. 2 provides a partial cross-sectional view inside one of the legs 5 or 17 of the walker, taken along line 2-2 in FIG. 1, wherein the other three legs are identical. As shown, each leg 5, 17 consists of a hydraulic cylinder 16 having a moveable piston 31 therein. In FIG. 1, each hydraulic cylinder 16 is indicated using a box 80. Preferably, dimension 22 of the piston 31 is one to two thousandths of an inch less then dimension 27 of the hydraulic cylinder 16, thereby allowing the piston 31 to move up and down in the hydraulic cylinder 16. Preferably, the inner wall 84 of each hydraulic cylinder 16 has a very low micro finish as well as a very low coefficient of friction. Additionally, preferably each piston 31 is made of a low coefficient of friction surface polymer which prevents scratching of the inner wall 84 of the hydraulic cylinder 16.

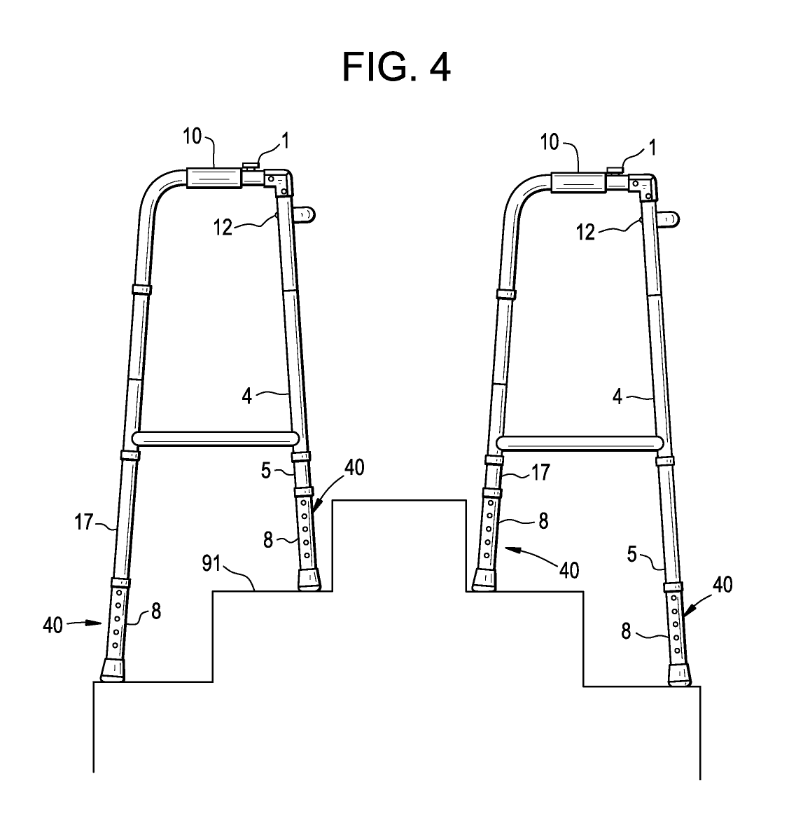

Each hydraulic cylinder 16 includes a seal mechanism 25 that allows for sealing at various fluid pressures. For each frame 4, the hydraulic cylinder 16 in the rear leg 17 is connected to the hydraulic cylinder 16 in the front leg 5 via flexible hydraulic tubing and fittings (indicated by lines 90 in FIG. 1), and the ball valve 1 which is located in the upper portion 51 of the walker 14. When a ball valve 1 of a given frame 4 is open, fluid can pass between the hydraulic cylinders 16 located in the front and back legs 5, 17. As such, the length of each of the legs 5, 17 of that particular frame 4 can be adjusted. Specifically, opening the ball valve 1 and pushing the front leg 5 against a surface (such as stair 91 in FIG. 4) will cause the front leg 5 to retract and the back leg 17 of that frame 4 to extend in response. Once the desired change in the lengths is achieved, the ball valve 1 can be closed, thus locking the leg lengths. In other words, leg length adjustment of the walker 14 is achieved by opening both ball valves 1, placing the legs 5 or 17 to be shortened on the upper treads of a stair and pushing down on the hand grips 10 of the walker 14 until the desired leg lengths are achieved, and then closing the ball valves 1. For level use, with the ball valves 1 open, one simply pushes the hand grips 10 down generally in the direction of the legs 5 or 17 that are to be shortened until the desired length is achieved, and then the ball valves 1 are closed, which locks the legs 5, 17 and prevents them from thereafter extending or contracting.

As shown in FIG. 2, the seal mechanism 25 of each hydraulic cylinder preferably does not include an o-ring 28. FIG. 3 illustrates an alternative embodiment which includes an o-ring 28. The seal outer diameter 26 shown in FIG. 3 is several thousandths of an inch larger than the inside dimension 22 shown in FIG. 2, which will seal up to four thousand pounds per square inch of fluid pressure but also requires a very high force to move the piston 31 up and down. As shown in FIG. 2, by omitting the o-ring 28 (see FIG. 3), the force to move the piston 31 up and down is greatly reduced, which makes it very easy to move the piston 31 up and down in the hydraulic cylinder 16. Thus, it requires very little force to adjust the length of the legs 5, 17 of the walker 14 for stair climbing and for walking on level ground. By providing that the seal 25 does not include an o-ring 28 as shown in FIG. 2, a hydraulic seal system is provided wherein the sealing pressure against the piston 31 and the inner wall 84 of the hydraulic cylinder is proportional to the fluid pressure which is pushing against the seal lips 19 to vary the seal 25 to the inside cylinder wall pressure.

What is claimed is:

1. A walker comprising at least one frame, wherein each frame comprises a plurality of legs, wherein the walker is configured such that when one leg is shortened, another leg extends in response.

2. A walker as recited in claim 1, wherein each leg comprises a hydraulic cylinder.

3. A walker as recited in claim 2, wherein each hydraulic cylinder comprises a piston which is moveable up and down.

4. A walker as recited in claim 1, wherein each frame comprises a ball valve which is selectively operable to allow the legs to selectively shorten and extend.

5. A walker as recited in claim 2, further comprising tubing that connects one hydraulic cylinder of the frame to another hydraulic cylinder of the frame, whereby fluid is flowable from one hydraulic cylinder to the other.

6. A walker comprising: a first leg; a second leg; a third leg; and a fourth leg, wherein the walker is configured such that if the first leg is shortened, the second leg extends in response, and wherein the walker is configured such that if the third leg is shortened, the fourth leg extends in response.

7. A walker as recited in claim 6, wherein each leg comprises a hydraulic cylinder.

8. A walker as recited in claim 7, wherein each hydraulic cylinder comprises a piston which is moveable up and down.

9. A walker as recited in claim 6, wherein the walker comprises a first frame and a second frame, wherein the first frame comprises said first leg and said second leg, and wherein the second frame comprises said third leg and said fourth leg, wherein said first frame comprises a first ball valve which is selectively operable to allow the first and second legs to selectively shorten and extend, and wherein said second frame comprises a second ball valve which is selectively operable to allow the third and fourth legs to selectively shorten and extend.

10. A walker as recited in claim 9, wherein said first leg comprises a first hydraulic cylinder, wherein said second leg comprises a second hydraulic cylinder, wherein said third leg comprises a third hydraulic cylinder, and wherein said fourth leg comprises a fourth hydraulic cylinder.

11. A walker as recited in claim 10, wherein tubing connects the first hydraulic cylinder to the second hydraulic cylinder, whereby fluid is flowable from the first hydraulic cylinder to the second hydraulic cylinder, and tubing connects the third hydraulic cylinder to the fourth hydraulic cylinder, whereby fluid is flowable from the third hydraulic cylinder to the fourth hydraulic cylinder.
